(19) United States
(12) Patent Application Publication
(10) Pub. No.: US 2006/0147647 A1
(43) Pub. Date: Jul. 6, 2006

(54) Apparatus and method for manufacturing nano carbon

(76) Inventors: Takeshi Azami, Tokyo (JP); Takashi Manako, Tokyo (JP); Tsutomu Yoshitake, Tokyo (JP); Yoshimi Kubo, Tokyo (JP); Sumio Iijima, Tokyo (JP); Masako Yudasaka, Tokyo (JP); Daisuke Kasuya, Tokyo (JP)

Correspondence Address: DICKSTEIN SHAPIRO MORIN & OSHINSKY LLP, 1177 AVENUE OF THE AMERICAS (6TH AVENUE), 41 ST FL., NEW YORK, NY, 10036-2714, US

(21) Appl. No.: 10/544,400

(22) PCT Filed: Feb. 10, 2004
(86) PCT No.: PCT/JP04/01384

§ 371 Date: Aug. 3, 2005

(30) Foreign Application Priority Data
Feb. 10, 2003 (JP) 2003-031927

(51) Int. Cl. C08J 7/04; B05B 5/025

(52) U.S. Cl. 427/510; 118/620

(57) ABSTRACT

Nanocarbon is produced stably in a large amount. In a production chamber (107), a graphite rod (101) having a cylindrical shape is fixed to a rotation apparatus (115) and is made capable of rotating with its axis being in the length direction of the graphite rod (101) and movable to the right or the left in the length direction. A side surface of the graphite rod (101) is irradiated with a laser beam (103) from a laser light source (111). A nanocarbon collecting chamber (119) is disposed in the direction of generation of plumes (109) so as to collect the generated carbon nanohorn aggregates 117.

### FIELD OF THE INVENTION

The present invention relates to a nanocarbon production apparatus and a nanocarbon production method.

### DESCRIPTION OF THE RELATED ART

In recent years, industrial application of nanocarbon is eagerly studied. Nanocarbon refers to a carbon substance having a fine structure of nano-scale, as represented by carbon nanotubes and carbon nanohorns and the like.

It is reported that a carbon nanotube made of a cylindrically rolled graphite sheet is produced by the laser evaporation method (laser ablation method) by which a source material carbon substance (hereinafter, referred to as graphite target in some cases) is irradiated with a laser beam in an inert gas atmosphere (Patent Document 1). In the Patent Document 1, a carbon pellet containing a catalyst is used as the graphite target, and the surface thereof is irradiated with a laser beam.

Also, a carbon nanohorn has a structure of tubular shape in which one end of a carbon nanotube has a conical shape. From its specific properties, application to various fields of the art is expected. Carbon nanohorns are typically aggregated in a form such that the conical parts protrude to the surface as horns (horns) with the tubes serving as a center by the van der Waals force acting among individual conical parts, so as to form carbon nanohorn aggregates.

It is reported that carbon nanohorn aggregates also are produced by the laser evaporation method (Patent Document 2). In the Patent Document 2, a surface of a graphite target having a cylindrical shape is irradiated with a laser beam, so as to produce carbon nanohorn aggregates.

Patent Document 1: Japanese Patent Application Laid-open No. 2000-313608

Patent Document 2: Japanese Patent Application Laid-open No. 2001-64004

### SUMMARY OF THE INVENTION

Here, in putting the carbon nanohorn aggregates into practical use, development of mass production technique is a critical issue. However, the method described in the above related art has room for improvement in view of continuous and stable production of carbon nanohorn aggregates.

The present invention has been made in view of the above circumstances, and an object thereof is to provide a production method and a production apparatus for stable mass production of carbon nanohorn aggregates. Also, another object of the present invention is to provide a production method and a production apparatus for stable mass production of nanocarbon.

The present inventors have made eager studies on a technique for efficient mass production of nanocarbon. The present invention has been completed on the basis of the new knowledge described above.

According to the present invention, there is provided a nanocarbon production apparatus comprising: a target holding unit that holds a graphite target having a cylindrical shape; a light source for irradiating a cylindrical surface of the graphite target with light; a movement unit for relatively moving one of the graphite target held by the target holding unit and the light source relative to the other one so as to move an irradiation position of the light on the cylindrical surface; and a collecting unit for collecting carbon vapor evaporated from the graphite target by irradiation with the light, as nanocarbon.

Also, according to the present invention, there is provided a nanocarbon production method, wherein irradiating a cylindrical surface of a graphite target having a cylindrical shape with light while moving the irradiation position of light, and collecting carbon vapor evaporated from the graphite target as nanocarbon.

In the present invention, irradiation with light is carried out on a cylindrical surface of a graphite target having a cylindrical shape. Here, in the laser evaporation method, the surface of a graphite target once irradiated with a laser beam is roughened. This is explained on a case where a surface of a graphite target having a cylindrical shape is irradiated with a laser beam. FIG. 3 is a view that exemplifies the manner of this in the case where a graphite target having a cylindrical shape is used. FIG. 3(c) is a cross-sectional view perpendicular to the length direction of a graphite rod 101 when it is irradiated with a laser beam 103 for the first time, and FIG. 3(a) is a enlarged view of a laser beam 103 irradiated part.

As shown in FIGS. 3(a) and 3(c), since the side surface irradiated with the laser beam 103 for the first time is a flat surface, a plume 109 is generated in a certain definite direction. On the other hand, FIG. 3(d) is a view illustrating a manner in which the side surface after irradiation with the laser beam 103 for one or more times in FIG. 3(c) is irradiated with the laser beam 103 again. FIG. 3(b) is an enlarged view of the laser beam 103 irradiated part. As shown in FIGS. 3(b) and 3(d), once irradiated with the laser beam 103, the side surface of the graphite rod 101 is roughened. When the surface-roughened position is irradiated with the laser beam 103 again, a change in the irradiation angle of the laser beam 103 and in the light-irradiated area on a side surface of the graphite rod 101 is generated, so that a fluctuation in the power density at the irradiated position is generated, and a disturbance also in the direction of the plume 109 generation is generated.

In the present invention, irradiation with light is carried out while moving the irradiated position on the cylindrical surface. For this reason, the magnitude of the power density at the irradiated position can be stabilized as compared with the case where a constant irradiation position is kept being irradiated with the laser beam. For this reason, nanocarbon having desired properties can be produced efficiently in a stable manner.

Also, in a graphite target having a cylindrical shape, the side surface that forms the cylindrical surface usually has a larger surface area than the flat end surfaces, so that a flat surface can be supplied as a new irradiation surface with certainty by carrying out the irradiation with light while moving the irradiated position on the cylindrical surface. For this reason, nanocarbon can be produced stably in a large amount.

Here, in the present specification, the “power density” is assumed to indicate the power density of light with which the graphite target surface is actually irradiated, that is, the power density at the light-irradiated position of the graphite target surface.

According to the present invention, there is provided a nanocarbon production apparatus comprising: a target holding unit that holds a graphite target having a cylindrical shape and rotates the graphite target around a central axis; a light source for irradiating a cylindrical surface of the graphite target with light; and a collecting unit for collecting carbon vapor evaporated from the graphite target by irradiation with the light, as nanocarbon.

Also, according to the present invention, there is provided a nanocarbon production method, wherein irradiating a cylindrical surface of a graphite target having a cylindrical shape with light while rotating the graphite target around a central axis, and collecting carbon vapor evaporated from the graphite target as nanocarbon.

In the present invention, while rotating a graphite target around a central axis, the cylindrical surface thereof is irradiated with light. For this reason, the light-irradiated position can be continuously changed with a simple configuration. Therefore, a new irradiation position can be efficiently supplied to produce nanocarbon stably in a large amount. By rotating a graphite target having a cylindrical shape around a central axis to irradiate the cylindrical surface with light, a new irradiation position can be supplied easily with a simple configuration as compared with the case of irradiating an end surface of the graphite target with light.

Here, in the present invention, the “central axis” refers to the axis that passes through the center of the cross section perpendicular to the length direction of the graphite target having a cylindrical shape and is horizontal to the length direction. Also, as a graphite target having a cylindrical shape, a graphite rod can be used, for example. Here, the “graphite rod” refers to a graphite target formed into a rod shape. As long as it has a rod shape, it does not matter whether it is hollow or solid. Also, the surface of the graphite target having a cylindrical shape that is irradiated with light is preferably a side surface of the graphite target having a cylindrical shape, as described above. In the present specification, the “side surface of a graphite target having a cylindrical shape” indicates the curved surface parallel to the length direction of the cylinder, and this surface is also called a cylindrical surface.

The nanocarbon production apparatus of the present invention may further be configured to comprise a movement unit that moves a relative position of the graphite target relative to the light source.

Also, in the nanocarbon production method of the present invention, irradiation with light may be carried out while moving an irradiation position of light.

By doing so, nanocarbon having desired properties may be obtained more stably.

In the nanocarbon production apparatus of the present invention, the movement unit may be configured to move an irradiation position of the light while allowing an irradiation angle of the light at the irradiation position of the light on the graphite target to be approximately constant.

Also, the nanocarbon using method of the present invention may comprise irradiating with the light so that an irradiation angle of the light to the cylindrical surface is approximately constant.

By doing so, the fluctuation of the power density of light at the irradiated position can be restrained with more certainty. For this reason, nanocarbon having desired properties can be stably produced at a high yield.

Here, in the present specification, the ratio of carbon nanohorns contained in a soot-like substance is also called “purity of carbon nanohorns” or “yield of carbon nanohorns”.

In the nanocarbon production method of the present invention, the irradiation with light may be irradiation with a laser beam. By doing so, light having a desired power density can be applied onto the surface of the graphite target with more certainty. For this reason, nanocarbon can be more stably produced.

The nanocarbon production apparatus of the present invention may be configured in such a manner that the collecting unit includes a collecting chamber that collects powders of the nanocarbon generated by the irradiation with light.

By doing so, the size of the collecting chamber can be easily designed to be a size suitable for the generated amount of nanocarbon. For this reason, the powders of the henerated nanocarbon can be collected with more certainty. Also, by separating the generated nanocarbon powders into the collecting chamber, the fluctuation of power density caused by irradiation of light applied onto the graphite target with nanocarbon can be restrained.

The nanocarbon production apparatus of the present invention may be configured to comprise a guiding unit that extends in a direction of plume generation from an irradiation position of the light by irradiation with the light and is in communication with the collecting chamber so as to guide the nanocarbon to the collecting chamber. By doing so, the nanocarbon generated by cooling of the carbon vapor flying out from the plume can be led to the collecting chamber and collected with more certainty.

In the nanocarbon production method of the present invention, the collecting nanocarbon may include collecting carbon nanohorns.

Also, in the nanocarbon production apparatus of the present invention, the nanocarbon may be carbon nanohorns.

Also, in the present invention, the carbon nanohorns may constitute carbon nanohorn aggregates.

By doing so, mass synthesis of carbon nanohorn aggregates can be carried out efficiently. In the present invention, the carbon nanohorn constituting the carbon nanohorn aggregates can be either a monolayer carbon nanohorn or a multi-layer carbon nanohorn.

Also, carbon nanotubes can be collected as the nanocarbon.

Here, any combination of these configurations and those obtained by conversion of the representation of the present invention among methods, apparatus, and others are also effective as modes of the present invention.

As described above with the use of FIG. 3, the surface of a graphite target once irradiated with a laser beam is roughened. When the position in a surface-roughened state is irradiated with the laser beam 103 again, the power density of the laser beam 103 is changed. For this reason, flat parts of the cylindrical surface of the graphite target are preferably supplied as the laser beam 103. Therefore, the present inventors have made further studies with a view to stable supply of flat surfaces, and reached the following inventions.

The nanocarbon production method of the present invention may include collecting carbon vapor evaporated from the graphite target as nanocarbon and flattening the surface of the graphite target irradiated with light; and irradiating the flattened surface of the graphite target with light again and collecting carbon vapor evaporated from the graphite target as nanocarbon.

Also, the nanocarbon production apparatus of the present invention may comprise a surface processing unit for flattening the surface of the graphite target irradiated with light.

In the present invention, “flattening” refers to a process of relatively reducing the degree of concavity and convexity on the surface of the graphite target as compared with that before the process. According to the nanocarbon production method of the present invention, though the graphite target surface is roughened by irradiation with light, this is flattened and the flattened position is irradiated with light again. Therefore, the graphite target surface irradiated with light is always maintained in a flat state. Therefore, the power density at the irradiated position of the graphite target surface is kept constant, thereby enabling stable mass synthesis of nanocarbon.

According to the present invention, there is provided a nanocarbon production method comprising: irradiating a surface of a graphite target having a cylindrical shape with light while rotating the graphite target around a central axis, collecting carbon vapor evaporated from the graphite target as nanocarbon, and flattening the surface of the graphite target irradiated with light; and irradiating the flattened surface with light again while rotating the graphite target around the central axis, and collecting carbon vapor evaporated from the graphite target as nanocarbon.

Also, according to the present invention, there is provided a nanocarbon production apparatus comprising: a target holding unit that holds a graphite target having a cylindrical shape and rotates the graphite target around a central axis; a light source for irradiating a surface of the graphite target with light; a surface processing unit for flattening the surface of the graphite target irradiated with light; and collecting unit for collecting carbon vapor evaporated from the graphite target by irradiation with light, as nanocarbon.

According to the present invention, a graphite target having a cylindrical shape is rotated around a central axis, so that the side surface roughened by irradiation with light is flattened. Then the flattened side surface is again irradiated with light. Thus, by performing irradiating with light and flattening while rotating the graphite target having a cylindrical shape, nanocarbon can be produced continuously and efficiently in a large amount.

In the nanocarbon production method of the present invention, irradiation with light can be carried out while moving an irradiation position of light in the irradiating the surface of the graphite target with light and in the irradiating the graphite target surface with light again.

Also, the nanocarbon production apparatus of the present invention may further comprise a movement unit that moves a relative position of the graphite target relative to the light source. As the movement unit, for example, in the case of irradiating with light while rotating the graphite target having a cylindrical shape around a central axis, a mode can be adopted that moves the position of the graphite target so as to move the irradiated position in the length direction of the graphite target.

By doing so, irradiating with light, flattening, and irradiating with light again can be carried out more efficiently and continuously, thereby enabling efficient mass production of nanocarbon.

For example, according to the present invention, there is provided a nanocarbon production method comprising: disposing a graphite target in a chamber, irradiating a surface of the graphite target with light while moving an irradiation position, collecting carbon vapor evaporated from the graphite target as nanocarbon, and flattening the surface of the graphite target irradiated with light; and irradiating the flattened surface of the graphite target with light again while moving the irradiation position without taking the graphite target out from the chamber, and collecting carbon vapor evaporated from the graphite target as nanocarbon.

In the nanocarbon production method of the present invention, the flattening the surface irradiated with light may comprise removing a part of the surface of the graphite target.

Also, in the nanocarbon production apparatus of the present invention, the surface processing unit may remove a part of the surface of the graphite target at a position different from the irradiation position of the light.

By doing so, the graphite target surface roughened by irradiation with light can be efficiently flattened. As long as the graphite target surface can be flattened, the method of removing a part thereof is not particularly limited; cutting, grinding, polishing, and the like can be raised as an example.

The nanocarbon production apparatus of the present invention may further comprise a dust collection unit for collecting dust of the graphite target generated in the surface processing unit. By doing so, the cut dust generated by cutting of the graphite target surface can be efficiently separated from the generated nanocarbon and collected.

In the nanocarbon production method of the present invention, the irradiating with light may comprise irradiating with a laser beam. By doing so, the wavelength and direction of light can be made constant, so that the condition of irradiating the graphite target surface with light can be controlled at a good precision, thus enabling selective production of a desired nanocarbon.

As described above, according to the present invention, by irradiating a cylindrical surface of a graphite target with light while relatively moving one of the graphite target having a cylindrical shape and the light source relative to the other one, the nanocarbon can be produced stably in a large amount. Also, according to the present invention, carbon nanohorn aggregates can be produced stably in a large amount.

### BRIEF DESCRIPTION OF THE DRAWINGS

The above-described objects and other objects, features, and advantages will be made more apparent from the preferable embodiments described below and the following drawings associated therewith.

FIG. 1 is a view illustrating one example of a configuration of a nanocarbon production apparatus according to the present invention.

FIG. 2 is a view for describing the configuration of the nanocarbon production apparatus of FIG. 1.

FIG. 3 is a view for describing a laser beam irradiation position of a solid carbon element substance.

FIG. 4 is a view illustrating one example of a configuration of a nanocarbon production apparatus according to the present invention.

FIG. 5 is a view illustrating one example of a configuration of a nanocarbon production apparatus according to the present invention.

FIG. 6 is a view describing the laser beam irradiation on the graphite target in the nanocarbon production apparatus of FIG. 5.

### DETAILED DESCRIPTION OF THE INVENTION

Hereafter, preferable embodiments of nanocarbon production apparatus and production method according to the present invention will be described by taking as an example a case where nanocarbon is carbon nanohorn aggregates.

### First Embodiment

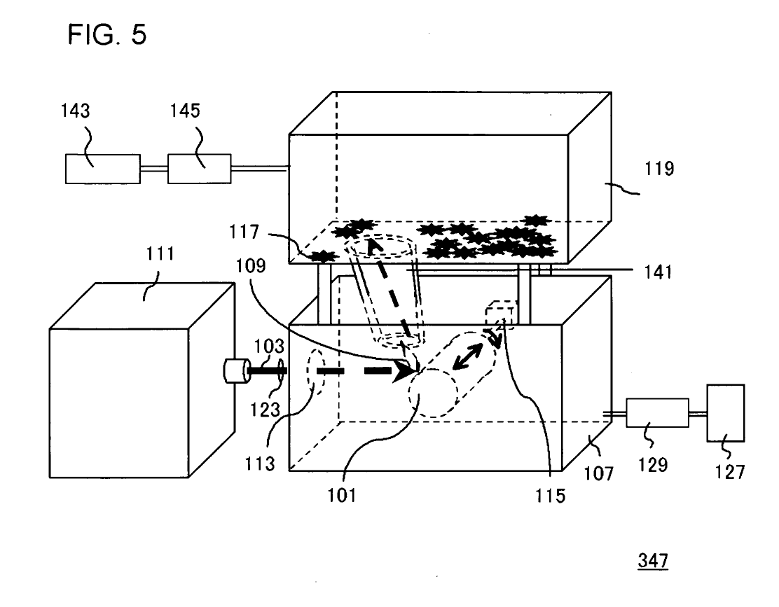

FIG. 5 is a view illustrating a configuration of a nanocarbon production apparatus 183 according to the present embodiment. Here, in the present specification, FIG. 5 and figures used for description of other production apparatus are schematic views, so that the size of each constituent member does not necessarily correspond to an actual dimension ratio.

A nanocarbon production apparatus 347 of FIG. 5 comprises a production chamber 107, a nanocarbon collecting chamber 119, a transport piping 141, a laser light source 111, a lens 123, a laser beam window 113, and a rotation apparatus 115. Further, the nanocarbon production apparatus 347 comprises an inert gas supplying unit 127, a flowmeter 129, a vacuum pump 143, and a pressure gauge 145.

The laser beam 103 emitted from the laser light source 111 is condensed by the lens 123 and is applied through the laser light source 111 to the graphite rod 101 in the production chamber 107. The graphite rod 101 is used as a solid carbon element substance acting as a target of the laser beam 103 irradiation.

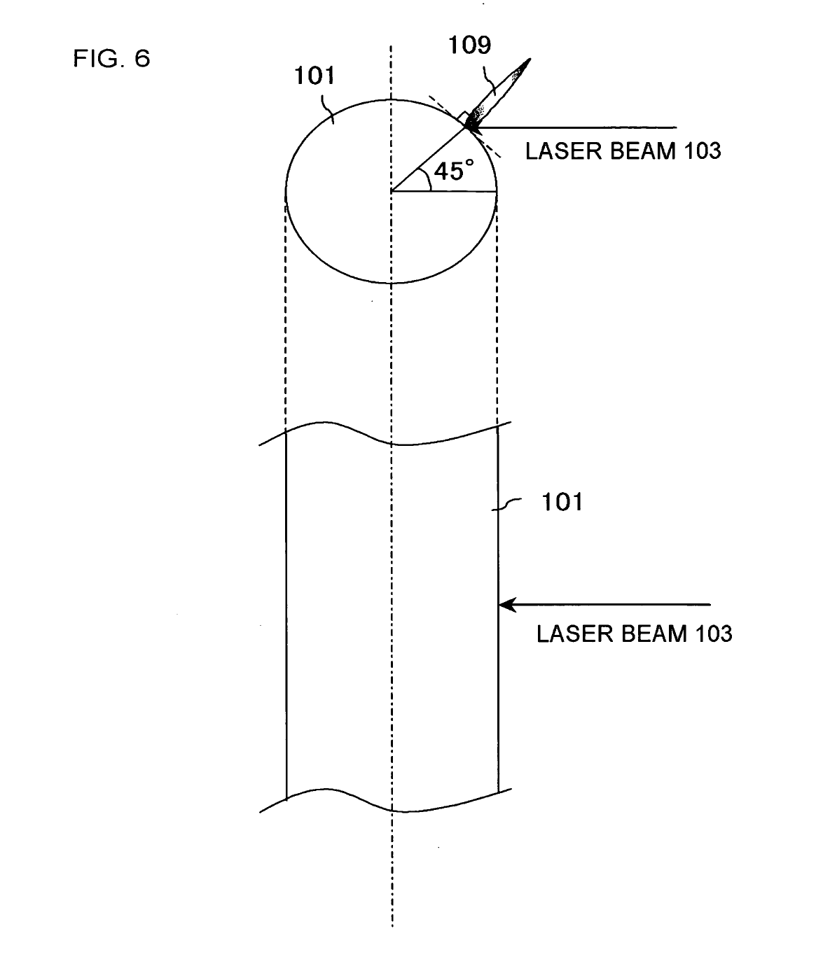

The laser beam 103 is applied onto the cylindrical surface of the graphite rod 101 so that the irradiation angle is constant. This manner will be explained using FIG. 6. FIG. 6 exemplifies a case where the cylindrical surface of the graphite rod 101 is irradiated with the laser beam 103 at an irradiation angle of 45 degree. As illustrated in FIG. 6, the laser beam 103 is incident onto the cylindrical surface in a direction perpendicular to the longitudinal axis of the graphite rod 101. Also, the irradiation angle at the irradiation position is 45 degree.

By rotating the graphite rod 101 around its central axis at a predetermined speed while keeping the irradiation angle of the laser beam 103 to be constant, the laser beam 103 can be continuously applied at a constant power density in the circumferential direction on the side surface of the graphite rod 101. Also, by sliding the graphite rod 101 in its length direction, the laser beam 103 can be continuously applied at a constant power density in the length direction of the graphite rod 101.

Also, when a surface of a graphite target is irradiated with the laser beam 103, a plume 109 is generated in a normal line direction of the surface of the graphite rod 101 at the irradiated position. Then, the carbon vapor flying out from the plume 109 is cooled to be nanocarbon. When the angle formed by the laser beam 103 and the normal line of the irradiated surface at the position irradiated with the laser beam 103 is small, the generated plume 109 returns to the laser beam 103 side, thus causing what is a so-called reflection of the laser beam 103.

At this time, when an end surface of the graphite rod 101, for example, is irradiated with the laser beam 103 to generate a plume 109 at the end surface, a state is generated such that the generated carbon nanohorn aggregates 117 float around in the vicinity of the optical path of the laser beam 103 from the irradiated surface. For this reason, when the laser beam 103 is applied, the laser beam 103 may pass through the generated carbon nanohorn aggregates 117. This may destroy the structure of the carbon nanohorn aggregates 117.

Also, when the carbon nanohorn aggregates 117 absorb the laser beam 103, the laser beam 103 is attenuated. Then the power density at the irradiated surface is decreased. Therefore, the generation of return light is a cause of decrease in the yield of the carbon nanohorn aggregates 117. Also, when the return light returns to the laser beam 103 side, the efficiency of collecting the plume 109 decreases.

Also, when the return light is generated, the return light returns to the optical member side such as the laser beam window 113 or the lens 123. With such a configuration, the soot-like substance tends to adhere to the optical members. When the soot-like substance adheres to the optical members, the laser beam 103 is absorbed, leading to a variation in the density of energy that is applied onto the graphite target. Also, the time required for maintenance of removing the soot-like substance is increased. For this reason, this is a cause of decrease in the production efficiency and the yield thereof.

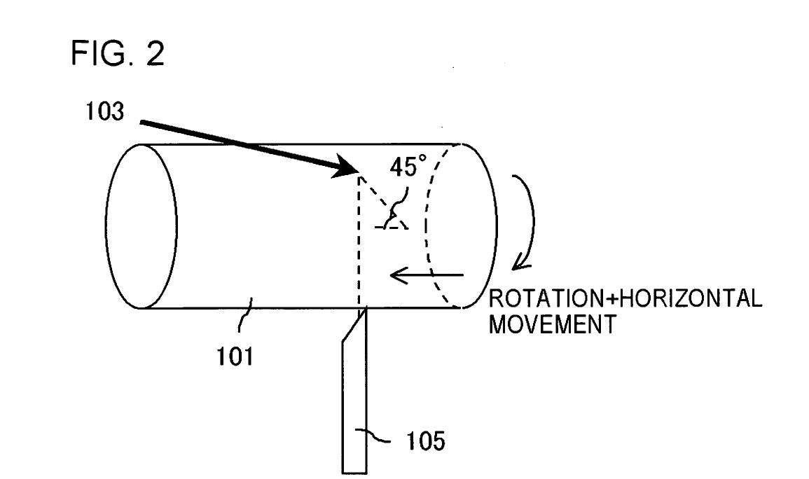

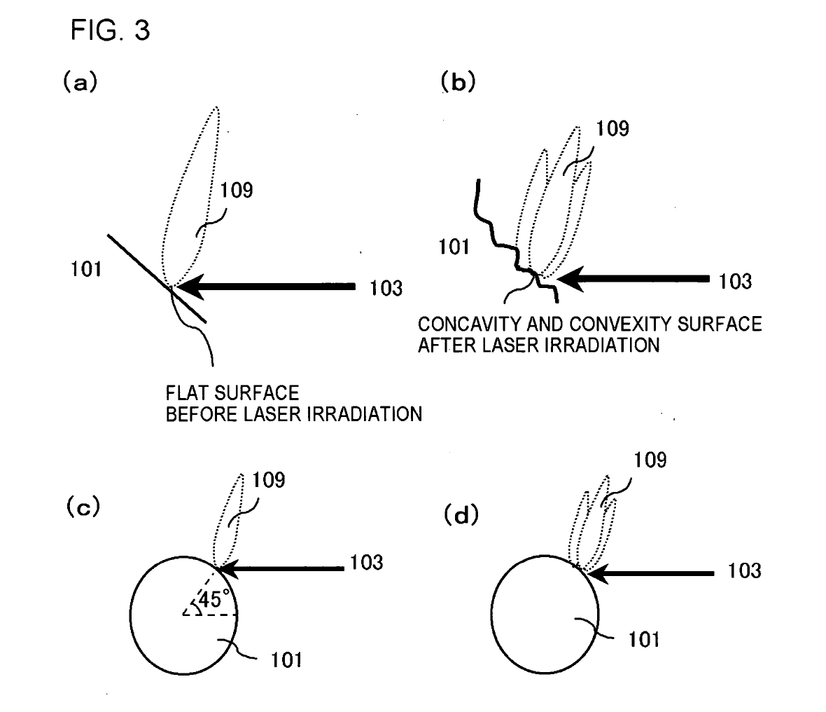

In the present embodiment, in order to produce the carbon nanohorn aggregates 117 stably at a high purity by restraining the generation of return light, it is preferable to set the irradiation angle to be 30 degree or more and 60 degree or less while rotating the graphite rod 101 around the central axis thereof. Here, in the present specification, the irradiation angle refers to the angle formed by the laser beam 103 and the line perpendicular to the surface of the graphite target at the position irradiated with the laser beam 103. When a graphite target having a cylindrical shape is used, the irradiation angle is the angle formed by the horizontal plane and the line segment connecting the irradiated position to the center of the circle in a cross section perpendicular to the length direction of the graphite rod 101, as shown in FIG. 2, FIG. 3(c), and FIG. 3(d).

By setting this irradiation angle to be 30 degree or more, the return light generated by reflection of the applied laser beam 103 can be restrained. Also, the generated plume 109 is prevented from directly hitting the lens 123 through the laser beam window 113. For this reason, this is effective in protecting the lens 123 and preventing adhesion of the carbon nanohorn aggregates 117 onto the laser beam window 113. Therefore, the power density of light applied to the graphite rod 101 can be stabilized, and the carbon nanohorn aggregates 117 can be produced stably at a high yield.

Also, by applying the laser beam 103 at 60 degree or less, the generation of amorphous carbon can be restrained, and the ratio of the carbon nanohorn aggregates 117 in the product, that is, the yield of the carbon nanohorn aggregates 117, can be improved. Further, it is particularly preferable that the irradiation angle is 45 degree. By irradiating at 45 degree, the ratio of the carbon nanohorn aggregates 117 in the product can be improved to a greater extent.

Also, since the nanocarbon production apparatus 347 has a configuration such that the side surface of the graphite rod 101 is irradiated with the laser beam 103, a change can be easily made by changing the irradiation angle of the side surface in a state where the position of the lens 123 is fixed. For this reason, the power density can be made variable, and can be adjusted with certainty. For example, in the case where the position of the lens 123 is fixed, the power density can be enhanced if the irradiation angle is set to be 30 degree, for example. Also, by setting the irradiation angle to be 60 degree, the power density can be controlled to be low.

The rotation apparatus 115 holds the graphite rod 101 and rotates it around the central axis thereof. For example, the graphite rod 101 can be rotated in a direction away from the laser beam 103 and the plume 109. By doing so, the generation of return light can be restrained with more certainty. In addition, the carbon nanohorn aggregates 117 can be collected with certainty while stably supplying a new irradiation surface to be subjected to irradiation with the laser beam 103. By being fixed to the rotation apparatus 115, the graphite rod 101 can be rotated around the central axis. Also, a configuration can be made such that the graphite rod 101 is movable in position, for example, in the direction along the central axis.

Also, as described above using FIG. 3, once irradiated with the laser beam 103, the surface of the graphite rod 101 is roughened. In the above-described Patent Document 1, a surface of a carbon pellet is irradiated with a laser. However, since it does not have amechanism for relatively moving the carbon pellet and the irradiation position of the laser beam, the laser is kept being applied to a certain definite position. For this reason, as the irradiation continues, the surface of the pellet is roughened, leading to a fluctuation in the power density.

On the other hand, in the nanocarbon production apparatus 347, a flat surface can continue to be supplied with a simple apparatus configuration such that the graphite rod 101 is rotated around the central axis and is moved in the axial direction. For this reason, the nanocarbon production apparatus 347 is capable of continuous production of nanocarbon, and can be used suitably for mass production. Also, the carbon nanohorn aggregates 117 can be obtained at a high purity.

Also, in a general concept, the side surface of the graphite rod 101 has a larger non-surface area than the end surfaces. For this reason, a new surface suitable for irradiation can be easily prepared simply by rotating the graphite rod 101 and horizontally moving it in the longitudinal direction. Therefore, the carbon nanohorn aggregates 117 can be produced with excellent production properties while simplifying the apparatus configuration.

Also, since the graphite rod 101 can be rotated around the central axis and moved in the longitudinal direction, the laser beam 103 can be applied while shifting the irradiation position by adjusting the rotation and movement conditions. For this reason, the condition for irradiation with the laser beam 103 can be easily adjusted.

The production chamber 107 and the nanocarbon collecting chamber 119 are connected by the transport piping 141. The side surface of the graphite rod 101 is irradiated with the laser beam 103 from the laser light source 111; the nanocarbon collecting chamber 119 is disposed via the transport piping 141 in the direction of the plume 109 generation during that time; and the generated carbon nanohorn aggregates 117 are collected into the nanocarbon collecting chamber 119.

The plume 109 is generated in a direction perpendicular to the tangential line of the graphite rod 101 at the position irradiated with the laser beam 103. Therefore, when the transport piping 141 is disposed in that direction, the carbon vapor can be efficiently led to the nanocarbon collecting chamber 119 to collect the powders of the carbon nanohorn aggregates 117. For example, when the irradiation angle is 45 degree, the transport piping 141 can be disposed in a direction that forms 45 degree to the plumb line.

The nanocarbon production apparatus 347 has a configuration such that the side surface of the graphite rod 101 is irradiated with the laser beam 103 while the graphite rod 101 is being rotated in the circumferential direction. The laser beam 103 is applied in a positional relationship in which the direction of the laser beam 103 does not correspond with the direction of the plume 109 generation. By doing so, the angle of the plume 109 generated on the side surface of the graphite rod 101 can be predicted in advance. For this reason, the position and angle of the transport piping 141 can be controlled with precision. Therefore, the carbon nanohorn aggregates 117 can be efficiently produced and also collected with certainty.

Next, a method of producing carbon nanohorn aggregates 117 using the nanocarbon production apparatus 347 of FIG. 5 will be explained specifically.

In the nanocarbon production apparatus 347, a highly pure graphite, for example, a round-rod-shaped sintered carbon or compressed formed carbon can be used, as the graphite rod 101.

Also, as the laser beam 103, a laser beam such as a high-output-power CO₂ gas laser beam is used. Here, the materials of the laser beam window 113 and the lens 123 are suitably selected in accordance with the kind of the laser beam 103 to be used. For example, when a CO₂ gas laser beam is to be used, the material for the laser beam window 113 and the lens 123 can be ZnSe.

Irradiation of the graphite rod 101 with the laser beam 103 is carried out in a reaction inert gas atmosphere such as rare gas of Ar, He, or the like, and in an atmosphere of, for example, 10³ Pa or more and 10⁵ Pa or less. Also, it is preferable to make the inert gas atmosphere after the gas inside the production chamber 107 is discharged in advance to reduce the pressure to be, for example, 10⁻² Pa or less.

Also, it is preferable to adjust the output power, the spot diameter, and the irradiation angle of the laser beam 103 so that the power density of the laser beam 103 on the side surface of the graphite rod 101 is approximately constant, for example, 5 kW/cm² or more and 30 kW/cm² or less, for example, 20±10 kW/cm².

The output power of the laser beam 103 is set to be, for example, 1 kW or more and 50 kW or less. Also, the pulse width of the laser beam 103 is set to be, for example, 0.02 sec or more, preferably 0.5 sec or more, more preferably 0.75 sec or more. By doing so, the accumulated energy of the laser beam 103 applied to the surface of the graphite rod 101 can be sufficiently ensured. For this reason, the carbon nanohorn aggregates 117 can be efficiently produced. Also, the pulse width of the laser beam 103 is set to be, for example, 1.5 sec or less, preferably 1.25 sec or less. By doing so, the fluctuation of surface energy density caused by excessive heating of the graphite rod 101 surface can be restrained, which leads to decrease in the yield of the carbon nanohorn aggregates. The pulse width of the laser beam 103 is more preferably set to be 0.75 sec or more and 1 sec or less. By doing so, both the generation ratio and the yield of the carbon nanohorn aggregates 117 can be improved.

Also, the rest width in the laser beam 103 irradiation can be set to be, for example, 0.1 sec or more, and is preferably set to be 0.25 sec or more. By doing so, with more certainty the overheating of the graphite rod 101 surface can be restrained.

Also, the spot diameter of the laser beam 103 on the graphite rod 101 side surface at the time of irradiation can be set to be, for example, 0.5 mm or more and 5 mm or less.

During the time the laser beam 103 is irradiated, the graphite rod 101 is rotated by the rotation apparatus 115 at a constant speed in the circumferential direction. The rotation number is set to be, for example, 1 rpm or higher and 20 rpm or lower.

Also, it is preferable to move the spot of the laser beam 103 at a speed (circumferential speed) of, for example, 0.01 mm/sec or more and 55 mm/sec or less. For example, in the case of applying the laser beam 103 onto the surface of a graphite target having a diameter of 100 mm, the above-described circumferential speed can be realized by rotating the graphite rod 101 having a diameter of 100 mm at a constant speed in the circumferential direction with the use of the rotation apparatus 115 and setting the rotation number to be, for example, 0.01 rpm or higher and 10 rpm or lower. Here, the rotation direction of the graphite rod 101 is not particularly limited; it is preferable to rotate the graphite rod 101 in the direction away from the laser beam 103. By doing so, the powders of the carbon nanohorn aggregates 117 can be led to the nanocarbon collecting chamber 119 to be collected with more certainty.

The soot-like substance collected into the nanocarbon collecting chamber 119 mainly contains the carbon nanohorn aggregates 117 and is collected, for example, as a substance containing carbon nanohorn aggregates 117 at 90 wt % or more.

### Second Embodiment

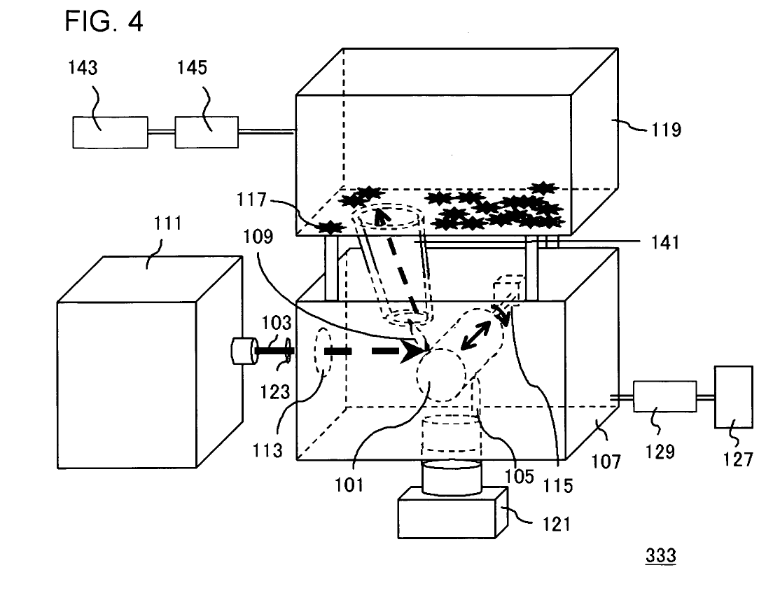

In the first embodiment, the irradiation with light maybe carried out while flattening the cylindrical surface of the graphite rod 101. FIG. 4 is a view illustrating one example of a configuration of a nanocarbon production apparatus according to the present embodiment. The basic configuration of the nanocarbon production apparatus 333 of FIG. 4 is similar to that of the nanocarbon production apparatus 347 (FIG. 5) according to the first embodiment; however, it is different in that a cutting tool 105 and a cut graphite collecting chamber 121 are provided.

In the present embodiment also, the graphite rod 101 is fixed to the rotation apparatus 115, and is rotatable around the central axis serving as an axis. Also, the graphite rod 101 is capable of positional movement.

Here, since the graphite rod 101 is rotated by the rotation apparatus 115, the region irradiated with the laser beam 103 is led to a position where the cutting tool 105 contacts with the graphite rod 101, and is cut at this position thereby to flatten the side surface. The cut dust of the graphite rod 101 generated by the cutting tool 105 is collected into the cut graphite collecting chamber 121 and is separated from the generated carbon nanohorn aggregates 117.

In the nanocarbon production apparatus 333, the positions of the laser light source 111 and the cutting tool 105 are fixed. Since the graphite rod 101 rotates around its central axis, the position irradiated with the laser beam 103 quickly moves to the position contacting with the cutting tool 105, and is flattened by the cutting tool 105. During this time, the graphite rod 101 moves in its longitudinal direction to change the position irradiated with the laser beam 103. The position of cutting by the cutting tool 105 also changes in accordance with the change in the irradiated position.

The manner of this is shown in FIG. 2. FIG. 2 is a view showing relationship between the laser beam 103, the cutting tool 105, and the graphite rod 101 in the nanocarbon production apparatus 333 of FIG. 4. As shown in FIG. 2, the laser beam 103 is applied so that the angle formed by the horizontal plane and the line segment connecting the irradiated position to the center of the cross section perpendicular to the length direction of the graphite rod 101, that is, the irradiation angle in this embodiment, is constant. By sliding the graphite rod 101 in its length direction while keeping the irradiation angle of the laser beam 103 to be constant, the laser beam 103 can be continuously applied at a constant power density in the length direction of the graphite rod 101.

Also, as described with the use of FIG. 3, once irradiated with the laser beam 103, the side surface of the graphite rod 101 is roughened. When the surface-roughened position is irradiated with the laser beam 103 again, a fluctuation in the power density at the irradiated position is generated, and a disturbance also in the direction of the plume 109 generation is generated. In this manner, when the surface once irradiated with the laser beam 103 is irradiated with the laser beam 103 again, the power density at the irradiated position cannot be made constant, thereby leading to a decrease in the yield of carbon nanohorn aggregates 117.

Therefore, in the nanocarbon production apparatus 333, the cutting tool 105 is disposed below the graphite rod 101, as shown in FIG. 2. When the cutting tool 105 is disposed below the position irradiated with the laser beam 103, the side surface of the graphite rod 101 irradiated with the laser beam 103 is successively rotated to move to the position of the cutting tool 105 to be cut, so that the irradiated position can be continuously flattened. For this reason, the surface irradiated with the laser beam 103 is always a flat surface. Thus, the power density at the laser beam 103 irradiation position can be made constant even if the graphite rod 101 is not taken out of the production chamber 107 for carrying out a flattening process. Therefore, the laser beam 103 can be continuously applied while keeping the graphite rod 101 disposed in the production chamber 107, whereby the carbon nanohorn aggregates 117 can be produced efficiently in a large amount.

Also, when the laser beam 103 is applied as shown in FIG. 2, the plume 109 is generated upwards, so that the carbon nanohorn aggregates 117 are generated upwards. Therefore, when the cutting tool 105 is disposed below the graphite rod 101, the generated carbon nanohorn aggregates 117 can be efficiently separated from the cut dust of the graphite rod 101 which is a source material cut by the cutting tool 105.

Here, as shown in FIG. 2, the position of disposing the cutting tool 105 is preferably at the position equal to or a little behind the laser beam 103 irradiation position in the direction of movement of the graphite rod 101. By doing so, a defect such that the side surface of the graphite rod 101 is cut before being irradiated with the laser beam 103 can be prevented with certainty.

As described above, in the nanocarbon production apparatus 333, the position irradiated with the laser beam 103 on the side surface of the graphite rod 101 having a cylindrical shape changes continuously, and the irradiation position is rotated to be flattened by the cutting tool 105, thereby enabling continuous production of carbon nanohorn aggregates 117. Also, since the graphite rod 101 acting as a graphite target can be repeatedly subjected to the laser beam 103 irradiation, the graphite rod 101 can be effectively used.

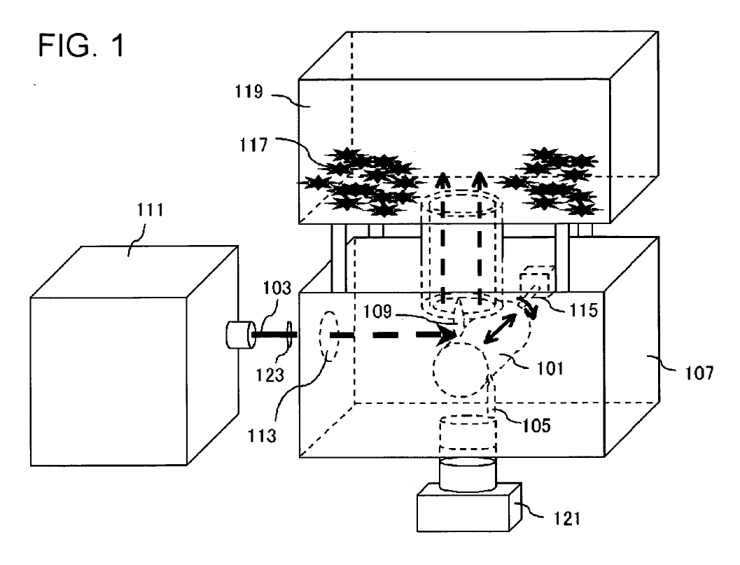

The cutting tool 105 disposed below the graphite rod 101 is not particularly limited as long as it has a configuration capable of flattening the graphite rod 101 side surface, so that those with various shapes and properties can be used. Also, though the cutting tool 105 is used in the production apparatus of FIG. 1, various cutting members, for example, a grinding member such as a file or a polishing member can be used as well in place of this. For example, a roller having a polishing paper (sand paper) disposed on an upper surface thereof, can be used. At this time, a configuration such that the upper surface of the roller having a polishing paper disposed thereon, for example, is rotated around a central axis perpendicular to the surface so as to flatten the cylindrical surface of the graphite rod 101, can be used. Also, the position of disposing the cut graphite collecting chamber 121 is not particularly limited as long as it is a position where the cut dust generated by the cutting tool 105 can be collected by being separated from the carbon nanohorn aggregates 117.

The apparatus of the nanocarbon production apparatus 333 has a configuration such that the soot-like substance obtained by irradiation with the laser beam 103 is collected into the nanocarbon collecting chamber 119; however, the soot-like substance can be collected by piling on a suitable substrate or by a method of fine particle collection using a dust bag. Also, an inert gas can be passed within the reaction container whereby the soot-like substance can be collected with the use of the stream of the inert gas.

The soot-like substance obtained by using the apparatus of the nanocarbon production apparatus 333 mainly contains the carbon nanohorn aggregates 117 and is collected, for example, as a substance containing carbon nanohorn aggregates 117 at 90 wt % or more. Also, after once being irradiated with the laser beam 103, the surface is flattened with the cutting tool 105, and then the irradiation is carried out again. Therefore, even when a predetermined position on the side surface of the graphite rod 101 is irradiated for plural times, the carbon nanohorn aggregates 117 can be produced at a high yield.

FIG. 1 is a view illustrating another configuration of a nanocarbon production apparatus according to this embodiment. The basic configuration of the nanocarbon production apparatus of FIG. 1 is the same as that of the apparatus of FIG. 4; however, the positional relationship of the graphite rod 101 to the laser beam 103 and the direction of disposing the transport piping 141 are different. In FIG. 1, the position a little lower than the top of the side surface of the graphite rod 101 is irradiated with the laser beam 103, and a plume 109 is generated in the normal line direction of the irradiated surface. In the apparatus of FIG. 1, the nanocarbon collecting chamber 119 is disposed in the direction substantially straightly above the direction of the plume 109 generation, so that the generated carbon nanohorn aggregates 117 are collected into the nanocarbon collecting chamber 119. Here, although not illustrated in FIG. 1, this apparatus also can include an inert gas supplying unit 127, a flowmeter 129, a vacuum pump 143, and a pressure gauge 145.

In the apparatus of FIG. 1 also, the side surface of the graphite rod 101 is irradiated with the laser beam 103 while the graphite rod 101 is being rotated. In FIG. 1, the position a little lower than the top of the side surface of the graphite rod 101 is irradiated with the laser beam 103, and a plume 109 is generated in the normal line direction of the irradiated surface. For this reason, the carbon nanohorn aggregates 117 can be efficiently produced.

In addition, after once being irradiated with the laser beam 103, the surface is flattened with the cutting tool 105, and then the irradiation is carried out again. For this reason, even if a predetermined position on the side surface of the graphite rod 101 is irradiated for plural times, the carbon nanohorn aggregates 117 can be stably produced with a high yield.

By using the nanocarbon production apparatus according to the above-described embodiment, the graphite rod 101 side surface irradiated with the laser beam 103 can be flattened and subjected to the laser beam 103 irradiation again, so that also in the production of carbon nanotubes, these can be produced stably in a large amount.

Here, the shape, the size of the diameter, the length, the shape of the tip end part, the interval between carbon molecules or carbon nanohorns, and the like of the carbon nanohorns constituting the carbon nanohorn aggregates 117 can be controlled in various ways by the condition of irradiation with the laser beam 103 and the like.

As shown above, the present invention has been described on the basis of the embodiments. These embodiments are exemplary, and it will be understood by those skilled in the art that various modifications can be made, and such modifications are also within the scope of the present invention.

For example, the above description is given taking as an example a case where carbon nanohorn aggregates are produced as nanocarbon; however, the nanocarbon produced by using a production apparatus according to the above embodiments is not limited to carbon nanohorn aggregates.

For example, carbon nanotubes can be produced as well with the use of the production apparatus of FIG. 1. In the case of producing carbon nanotubes, it is preferable to adjust the output power, the spot diameter, and the irradiation angle of the laser beam 103 so that the power density of the laser beam 103 on the side surface of the graphite rod 101 is approximately constant, for example, 50±10 kW/cm².

Also, a catalyst metal is added to the graphite rod 101, for example, at 0.0001 wt % or more and 5 wt % or less. As the metal catalyst, for example, a metal such as Ni or Co can be used.

### EXAMPLE

In this Example, carbon nanohorn aggregates 117 were produced with the use of the apparatus shown in FIG. 5. A sintered round-rod carbon having a diameter of 100 mm and a length of 250 mm was used as the graphite rod 101, and this was fixed to the rotation apparatus 115 in the production chamber 107. After the gas in the production chamber 107 was discharged to reduce the pressure to 10⁻³ Pa, Ar gas was introduced to attain an atmosphere pressure of 10⁵ Pa. Subsequently, the graphite rod 101 was rotated at a rotation number of 6 rpm at room temperature, and the side surface thereof was irradiated with the laser beam 103 while horizontally moving it at 0.3 mm/sec.

A high-output-power CO₂ laser beam was used as the laser beam 103, and continuous oscillation was made with an output power of 3 to 5 kW, a wavelength of 10.6 μm, and a pulse width of 5 sec. Also, the angle formed by the horizontal plane and the line segment connecting the irradiation position to the center of the circle in a cross section perpendicular to the length direction of the graphite rod 101, that is, the irradiation angle, was set to be 45 degree, and the power density on the side surface of the graphite rod 101 was set to be 20 kW/cm²±10 kW/cm².

The obtained soot-like substance was subjected to TEM observation. Also, by the Raman spectroscopy, the strengths at 1350 cm⁻¹ and 1590 cm⁻¹ were compared to calculate the yield of the carbon nanohorn aggregates 117.

The obtained soot-like substance was observed with a transmission electron microscope (TEM), with the result that the carbon nanohorn aggregates 117 were dominantly generated, and the particle diameter thereof was within a range from 80 nm to 120 nm. Also, the yield of the carbon nanohorn aggregates 117 in the obtained total soot-like substance was determined by the Raman spectroscopy, giving a high yield of 90% or more.

In this Example, the carbon nanohorn aggregates 117 were obtained at a high yield by irradiating the side surface of the graphite rod 101 irradiated with the laser beam 103 again while rotating the graphite rod 101 irradiated with the laser beam 103 around the central axis. Also, it was made clear that this process is a continuous process suitable for mass production of carbon nanohorn aggregates.

1. A nanocarbon production apparatus comprising:
a target holding unit that holds a graphite target having a cylindrical shape;
a light source for irradiating a cylindrical surface of said graphite target with light;
a movement unit for relatively moving one of said graphite target held by said target holding unit and said light source relative to the other one so as to move an irradiation position of said light on said cylindrical surface; and
a collecting unit for collecting carbon vapor evaporated from said graphite target by irradiation with said light, as nanocarbon.

2. A nanocarbon production apparatus comprising:
a target holding unit that holds a graphite target having a cylindrical shape and rotates said graphite target around a central axis;
a light source for irradiating a cylindrical surface of said graphite target with light; and
a collecting unit for collecting carbon vapor evaporated from said graphite target by irradiation with said light, as nanocarbon.

3. The nanocarbon production apparatus according to claim 2, further comprising a movement unit that moves a relative position of said graphite target relative to said light source.

4. The nanocarbon production apparatus according to claim 1, wherein said movement unit is configured to move an irradiation position of said light while allowing an irradiation angle of said light at the irradiation position of said light on said graphite target to be approximately constant.

5. The nanocarbon production apparatus according to claim 1, wherein said collecting unit includes a collecting chamber that collects powders of said nanocarbon generated by said irradiation with light.

6. The nanocarbon production apparatus according to claim 5, comprising a guiding unit that extends in a direction of plume generation from an irradiation position of said light by irradiation with said light and is in communication with said collecting chamber so as to guide said nanocarbon to said collecting chamber.

7. The nanocarbon production apparatus according to claim 1, wherein said nanocarbon is carbon nanohorn aggregates.

8. A nanocarbon production method, wherein irradiating a cylindrical surface of a graphite target having a cylindrical shape with light while moving the irradiation position of light, and collecting carbon vapor evaporated from said graphite target as nanocarbon.

9. A nanocarbon production method, wherein irradiating a cylindrical surface of a graphite target having a cylindrical shape with light while rotating said graphite target around a central axis, and collecting carbon vapor evaporated from said graphite target as nanocarbon.

10. The nanocarbon production method according to claim 9, wherein irradiation with light is carried out while moving an irradiation position of light.

11. The nanocarbon production method according to claim 8, comprising irradiating with said light so that an irradiation angle of said light to said cylindrical surface is approximately constant.

12. The nanocarbon production method according to claim 8, wherein said irradiation with light is irradiation with a laser beam.

13. The nanocarbon production method according to claim 8, wherein carbon nanohorn aggregates are collected as said nanocarbon.
